(19) United States
(12) Patent Application Publication
(10) Pub. No.: US 2008/0289906 A1
(43) Pub. Date: Nov. 27, 2008

(54) Single Line Distributor

(76) Inventor: Michael Przybylsky, Berlin (DE)

Correspondence Address: FISH & RICHARDSON, PC, P.O. BOX 1022, MINNEAPOLIS, MN, 55440-1022, US

(21) Appl. No.: 11/660,134

(22) PCT Filed: Jun. 13, 2005
(86) PCT No.: PCT/EP05/06299

§ 371 Date: Nov. 16, 2007

(30) Foreign Application Priority Data
Aug. 12, 2004 (DE) 10 2004 039 353.2

(51) Int. Cl. F16N 27/00

(52) U.S. Cl. 184/7.4

(57) ABSTRACT

The invention relates to a single line distributor (1) for dosed discharge of lubricant at a lubricating point, comprising a control device (9) which consists of a control element (5) which can be moved from a base position into a discharge position and is pressed by a pre-tensing element (7) into said base position, and a control chamber which is connected to an inlet (2) and which is separated from a dosing chamber by means of said control element (5), in addition to a dosing device (24) comprising a dosing piston (16), a dosing chamber (6) which is connected to a discharge opening (21), and an actuating chamber (13) which is separated from the dosing chamber (6) by the dosing piston (16) and which is adjacent to the control element (5). The control device (9) is surrounded by the dosing device (24) in order to provide a single line distributor which enables the ratio between dosing amount and construction size to be increased.

The invention relates to a single line distributor for dosed discharge of lubricant at a lubricating point, with a control device comprising a control element which can be moved from a normal position into a discharge position and which is pressed by a biasing element into the normal position, and a control chamber which is connected to an inlet opening and which is separated from a dosing chamber by means of the control element, and with a dosing device comprising a dosing piston, the dosing chamber which is connected to a discharge opening, and an actuating chamber which is separated from the dosing chamber by the dosing piston and which is adjacent to the control piston, whereby the actuating chamber is connected to the control chamber in the discharge position and is connected to the dosing chamber in the normal position.

Single line distributors or dosing distributors of the type mentioned are known from the prior art and are used as a part of central lubricating devices that discharge a dosed lubricant from a central lubricant source at connected lubricating points. Each single line distributor is connected to the lubricant source by an inlet opening, whereby the lubricant source sequentially presses pressurised lubricant into the single line distributors. The lubricant pressure can be generated, for example, by a manual or motorized pump of the lubricant source. At the same time, each single line distributor is actuated by the pressurised lubricant, which is conducted into the actuating chamber, by means of which said single line distributor discharges a predetermined amount of lubricant, which is stored in the dosing chamber of the single line distributor. After the discharge of the amount of lubricant, the pressure in the single line distributor at the inlet opening is relieved by a pressure drop, which is, for example, caused by switching off the pump. At the same time, the single line distributor, which moves back into the normal position, stores the predetermined amount of lubricant for its next actuation. For this, the lubricant originally used for actuating the single line distributor is redirected from the actuating chamber into the dosing chamber in the course of the movement back into the normal position. The lubricant consequently simultaneously serves as a control medium that actuates the single line distributor. With the help of single line distributors, central lubricating devices with few, widely spaced lubricating points, such as, for example, in construction machines or agricultural machines, can be economically developed without the need for control lines.

Important to the function of the known single line distributors is a sufficiently large pressure relief of the supplied lubricant after the actuation, because the single line distributor must move back, against the lubricant pressure, into its normal position and redirect the lubricant from the actuating chamber into the dosing chamber. The use of viscous lubricants, such as grease, for example, in conjunction with long lubricant lines can result in the pressure relief in the lubricant line being too small. This problem is additionally intensified at low temperatures, such as in winter, for example, by the increasing consistency of the lubricant. Consequently, if the residual pressure of the lubricant supplied to the inlet opening is too high, no lubricant can be stored inside the single line distributor. This results in no or too little lubricant being discharged at the lubricating point the next time the single line distributor is actuated, and the lubricating point consequently remains without lubrication or is not sufficiently lubricated. As a result, there is increased wear on the components to be lubricated, such as bearings and guides, as a result of which damage and high costs can arise.

A solution to this problem is offered by the single line distributor of DE 203 09 553 U1, in which a valve piston can be moved, against a reset spring, from a starting position into a dosing position when the lubricant is pressurised. In the dosing position, a dosing piston is actuated against a second reset spring by the lubricant pressure, and a stored amount of lubricant is discharged at a lubricating point. When the pressure is relieved, the valve piston and dosing piston move, one after the other, back to their starting positions because of the two reset springs, and they store lubricant in a dosing chamber for the next actuation.

Detrimental in the case of the single line distributor of DE 203 09 553 U1 is its relative large construction size. Because the installation space available in many applications is limited, the single line distributor of DE 203 09 553 U1 can often not be used because of its large construction size.

In the prior art, single line distributors that can be built smaller are implemented with a rerouting collar, which controls the lubricant flow in the single line distributor. Of disadvantage in the single line distributors with rerouting collars is their relatively small dosing amount. In order to supply lubricating points with high lubricant consumption, single line distributors with rerouting collars must therefore be actuated a number of times, or a number of single line distributors must work together to supply a lubricating point.

The object of the present invention is therefore to provide a single line distributor in which the ratio between dosing amount and construction size is increased with respect to the known single line distributors.

According to the invention, this object is solved in that the control device is surrounded by the dosing device.

As a result of this structurally surprisingly simple solution, the construction size of the single line distributor according to the invention can be reduced, without it being necessary to decrease the dosing amount that can be discharged. If a lubricating point has a large lubricant demand and there is only a limited installation space, it is no longer necessary, as in the case of the single line distributors with rerouting collar, for example, to use a number of single line distributors for each lubricating point, with the result that the costs for the central lubricating device can be advantageously reduced.

The single line distributor improved in this way can be further developed by means of various mutually independent embodiments, each of which is advantageous in itself. The following is a brief discussion of these embodiments and the advantages associated with each of the embodiments.

For example, the control element can be arranged in a control cylinder and the dosing piston can be arranged movable around the control cylinder. This has the advantage that the control cylinder is configured as a structurally simple guide element for both the control element and the dosing piston. The size of the guiding surfaces between the control cylinder and the control element or dosing piston is designed here in such a way that it is impossible for the control element or dosing piston to tilt or jam.

In order to form an additional guide element for the dosing piston, the dosing piston can be arranged in a dosing cylinder in such a way that it can move axially. Furthermore, the dosing piston can be formed as a ring piston, which can be manufactured especially economically as a rotationally-symmetrical turned part.

In a further advantageous configuration, the dosing chamber can be divided into two sub-chambers, whereby the inner sub-chamber, which is adjacent to the control element, is formed in the control cylinder and the outer sub-chamber, which is adjacent to the dosing piston, is formed in the dosing cylinder. This has the advantage that the dosing chamber can easily be designed to be adjacent to both the control element and the dosing piston. Furthermore, the volume of the inner sub-chamber, which is adjacent to the control element, can be smaller than that of the outer sub-chamber, which is adjacent to the dosing piston. In this way, the dosing amount of the single line distributor according to the invention is increased, because only the lubricant found in the outer sub-chamber is discharged by the dosing piston at the lubricating point.

Furthermore, the two sub-chambers of the dosing chamber can be connected to each other by a passage in the control cylinder. This has the advantage that the passage in the control cylinder is especially simple to manufacture and the single line distributor is easy to install. In this case, the passage is arranged on the control cylinder in such a way that it is not blocked or swept across by the dosing piston at any time, so that the two sub-chambers of the dosing chamber are connected to each other at all times.

In an advantageous further configuration, at least one sealing element can be arranged on the dosing piston, by means of which the dosing piston is arranged between the dosing cylinder and the control cylinder in such a way that it is sealed. This has the advantage that no lubricant can flow past the dosing piston between the actuating chamber and the dosing chamber in a way that it interferes with the function and changes the predetermined dosing amount.

In order to redirect the lubricant located in the actuating chamber into the dosing chamber after the discharge of the lubricant at the lubricating point, the dosing piston can be pressed in the direction of the actuating chamber by at least one additional element. The element, e.g., a compression spring, in this case is developed in such a way that the generated bias force presses the dosing piston in the direction of the actuating chamber, against the flow resistance of the lubricant. Furthermore, the additional bias element can be arranged within the dosing chamber, as a result of which the single line distributor is structurally especially simply configured and is easy to install. The dosing piston can be configured with a long, axial guiding surface around the control cylinder and a flange, against which the additional bias element is supported axially.

In a further advantageous configuration, a control opening can be formed in the control cylinder, whereby the actuating chamber is connected to the dosing chamber in the normal position and to the control chamber in the discharge position by means of this control opening. This has the advantage that the connection between the interior of the control cylinder and the actuating chamber is especially simple to manufacture from the production point of view, and the manufacturing costs are reduced as a result. This is particularly advantageous in comparison to the single line distributor in DE 203 09 553 U1, in which the control opening is configured by means of a number of boreholes, which must be sealed against the exterior and which are complicated to manufacture. Furthermore, the long control opening of DE 203 09 553 U1 disadvantageously increases the volume of the actuating chamber, which leads to dosing imprecisions when the dosing amounts are small, caused by the compressibility of the lubricant. This problem is solved in the case of the single line distributor according to the invention by the short, small-volume control opening in the wall of the control cylinder. The control opening in this case is arranged at a point in the control cylinder at which it cannot be closed by the dosing piston and is consequently always connected to the actuating chamber.

In order to further simplify the single line distributor structurally, one of the axial ends of the control cylinder can be formed as the inlet opening. Furthermore, one of the axial ends of the control cylinder can be formed as the outlet opening. Consequently, the one axial end of the control cylinder can be formed as the inlet opening and the other as the outlet opening, as a result of which the control cylinder can be economically manufactured as a rotationally-symmetrical turned part.

In an advantageous further configuration, an actuating channel can be formed in the control element, by means of which the actuating chamber is connected to the control chamber in the discharge position and separated from the control chamber in the normal position. As a result of this configuration, the control element does not have to be moved axially over the control opening in order to connect the actuating chamber and the dosing chamber. This has the advantage that in the normal position, when the actuating chamber is connected to the dosing chamber, the control element is directed through the control cylinder along the entire circumference. Furthermore, an orifice of the actuating channel can be formed on the circumference, across the stroke axis of the control element, with the orifice being at least partially overlapped by the control opening in the discharge position and closed by the control cylinder in the normal position.

In a further advantageous configuration, a flow channel can be formed in the control element, whereby this flow channel connects the actuating chamber to the dosing chamber in the normal position and separates it from the dosing chamber in the discharge position. In this way, the guidance of the control element is guaranteed along the entire circumference even during the flow, as with the actuating channel. Furthermore, an orifice of the flow channel can be formed on the circumference, across the stroke axis of the control element, with the orifice being at least partially overlapped by the control opening in the normal position and closed by the control cylinder in the discharge position.

In order to lubricate the control element that is guided in the control cylinder, the control element can have two circumferential grooves running radially to the stroke axis, with the two orifices, one for the actuating channel and one for the flow channel, arranged one in each grove. The wall of the control cylinder is moistened with lubricant by the circumferential groove during the stroke movement, as a result of which the frictional resistance between the control element and the control cylinder is reduced. Furthermore, the pressure is equalized on the circumference of the control element as a result of the circumferential grooves. This prevents the creation of a hydraulic lateral force on the control element by the lubricant, which would make the control element tight.

Furthermore, the control element can comprise at least one sealing material that seals the control element with respect to the control cylinder. This ensures that no lubricant can flow past the control element, for example, from the control chamber into the dosing chamber.

The play between the control element and the control cylinder is especially advantageous if it is large at low temperatures and small at high temperatures. The reason for this is that lubricants, such as grease, for example, are especially viscous at low temperatures and consequently generate high shearing forces on the control element. A large amount of play in the control element reduces the shearing forces. On the other hand, the lubricants have a low viscosity at high temperatures, and a small amount of play in the control element seals the control element with respect to the control cylinder. In order to achieve the optimal control element play at various temperatures, the control element and the control cylinder can be produced from materials with different linear expansion coefficients and the play between the control element and the control cylinder can be greater at a first operating temperature than at a second operating temperature, which is higher than the first.

In order to change the dosing amount of the single line distributor according to the invention, the single line distributor can comprise an adjustment device, by means of which the axial stroke of the dosing piston can be adjusted. Furthermore, the adjustment device can comprise a dosing piston stop arranged at a fixed position in the stroke direction of the dosing piston, whereby this dosing piston stop is arranged at the dosing cylinder or dosing piston in such a way that it is interchangeable. Alternatively, the adjustment device can comprise a dosing piston stop that can be set at various positions in the stroke direction of the dosing piston, whereby this dosing piston stop is arranged at the dosing cylinder or dosing piston. In this way, the adjustment device is of a simple structure. Furthermore, the adjustment device can comprise a dosing piston stop that can be set at various positions in the stroke direction of the dosing piston, whereby this dosing piston stop is connected to an adjustment screw that is arranged at the dosing cylinder in such a way that it can be moved. This has the advantage that the outside length of the single line distributor does not change, even in the event of various settings of the dosing amount.

In addition to the single line distributor described above and its further configurations, the invention also relates to an arrangement for the dosed discharge of a lubricant at a number of lubricating points, with this arrangement being equipped with a number of single line distributors and with a lubricant distributor channel that can be connected to a lubricant source, whereby the single line distributors are connected to the lubricant distributor channel and mounted so that they protrude outwards from the lubricant distributor channel.

In order to reduce the construction size of the arrangement while keeping the dosing amount the same or increasing it, the single line distributors are developed in accordance with one of the abovementioned embodiments.

In an advantageous configuration of the arrangement according to the invention, the single line distributors can be arranged next to one another on the lubricant distributor channel with alternating ones protruding in the same protrusion direction from the lubricant distributor channel, whereby the two protrusion directions are arranged in such a way that they form a V-shape. This has the advantage that especially a large number of single line distributors can be arranged next to one another without restricting their accessibility. Furthermore, the angle between the two protrusion directions can be a small acute angle, preferably roughly 20°, as a result of which an especially compact construction of the arrangement can be realised. Alternatively, any other angles are also possible between the protrusion directions. Furthermore, it is also possible to arrange a number of V-shaped single line distributor rows on the circumference of the lubricant distributor channel in the shape of a star, in order to supply an especially large number of lubricating points from one lubricant distributor channel. In order to achieve the simplest housing construction possible, the arrangement can also comprise a single row, however.

In the following, the invention is explained by way of example, with reference to the accompanying drawings. The various characteristics here can be combined independently of one another, as was already explained above in the individual advantageous configurations.

It is shown in the following:

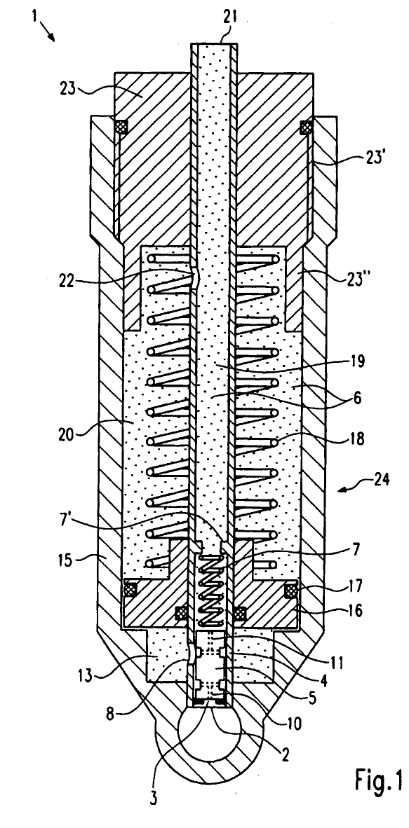

FIG. 1 an embodiment of a single line distributor according to the invention shown schematically in a side-view section, in a first operating position;

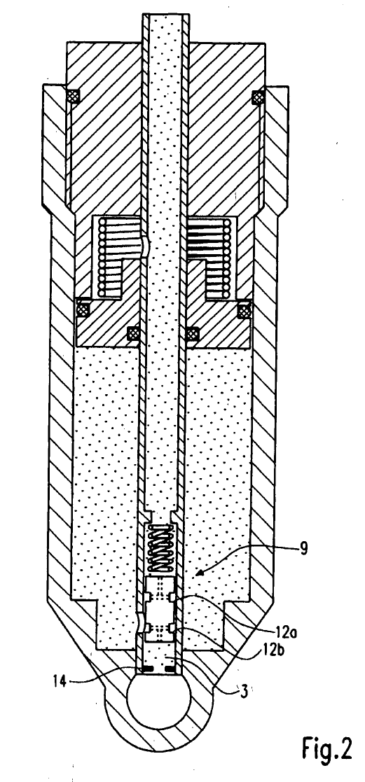

FIG. 2 the single line distributor from FIG. 1 in a second operating position;

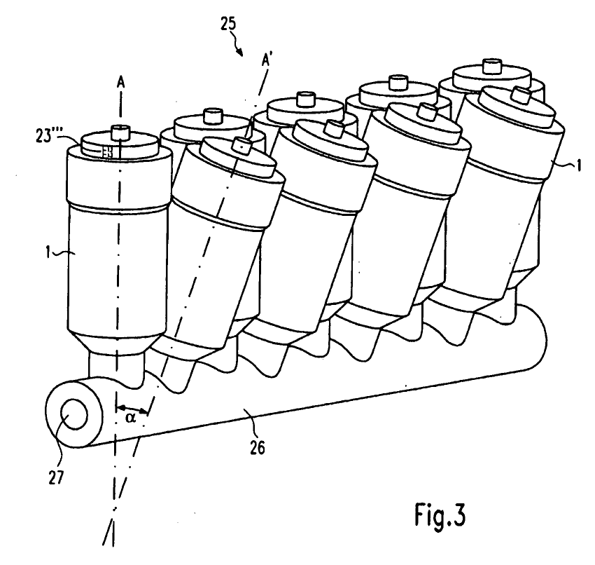

FIG. 3 schematically an embodiment of an arrangement according to the invention in a perspective view;

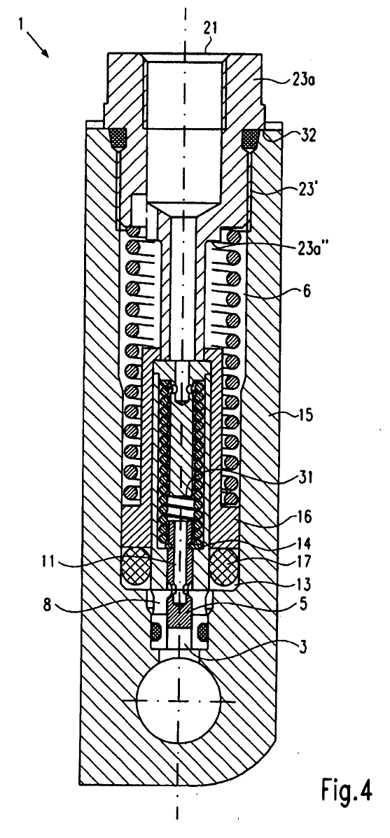

FIG. 4 a further embodiment of a single line distributor according to the invention;

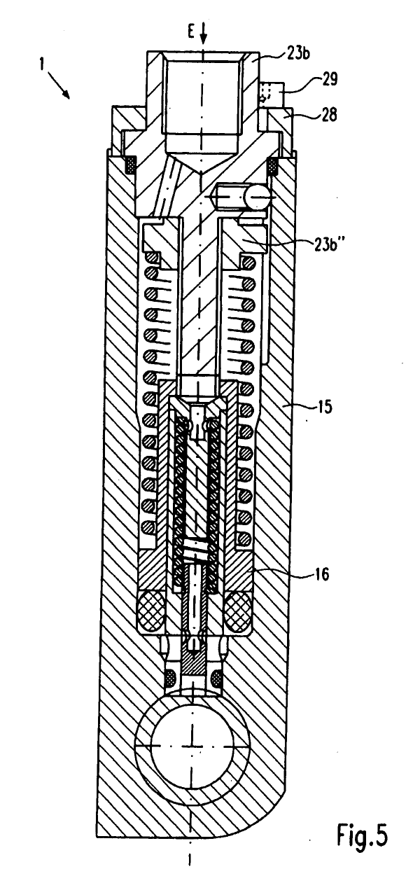

FIG. 5 an additional embodiment of a single line distributor according to the invention.

First the general configuration of a single line distributor according to the invention is described, with reference to FIGS. 1 and 2.

FIG. 1 shows a single line distributor 1 in a schematic sectional view. The single line distributor 1 comprises a control device 9 and a dosing device 24.

The control device 9 has an inlet opening 2 through which a lubricant, such as oil or grease, can be introduced into the single line distributor 1. The lubricant in this case can be directed to the inlet opening 2 by a lubricant pump, not shown in FIG. 1, and sequentially pressurised. The inlet opening 2 opens out into a control chamber 3, which is arranged in a control cylinder 4 and separated from a dosing chamber 6 by a control element 5, which is arranged in the control cylinder 4 in such a way that it can be moved axially. Furthermore, a bias element 7, in the form of a spring, is arranged at the control element 5, whereby this bias element 7, with the control element 5, the control cylinder 4 and the control chamber 3, and together with a control borehole 8 arranged in the wall of the control cylinder 4, forms the control device 9 of the single line distributor 1 according to the invention.

The control device 9 controls the lubricant flow within the single line distributor 1 according to the invention.

In the embodiment shown in FIG. 1 by way of example, the control element 5 belonging to the control device 9 is developed as a cylindrical piston that is arranged in the control cylinder 4 in such a way that it can move axially. The outer diameter of the control element 5 here is formed so that it is smaller than the inside diameter of the control cylinder 4, so that the wall of the control cylinder 4 forms a slideway for the control element 5. The length of the control element 5 in this case is greater than the diameter, in order to hold the control element 5 within the control cylinder 4 with a large guiding surface without allowing it to tilt.

The control element 5 can be moved from the normal position shown in FIG. 1 to a discharge position shown in FIG. 2.

An actuating channel 10 and a flow channel 11 are formed in the control element 5. Two circumferential grooves 12, axially spaced from one another, are arranged along the circumference of the control element 5. The actuating channel 10 runs from the axial end of the control element 5 adjacent to the control chamber 3 to the circumferential groove 12a, which lies in the direction of the control chamber 3. The flow channel 11 runs from the other circumferential groove 12, which lies in the direction of the dosing chamber 6, to the control element 5 axial end that faces the dosing chamber 6. The actuating channel 10 and the flow channel 11 are each developed as a transverse borehole that diametrically penetrates the circumferential grooves 12a, 12b, whereby each of these transverse boreholes is connected to the respective axial end of the control element 5 by an axial borehole.

In the normal position of the control element 5 shown in FIG. 1, the control borehole 8 is arranged in the wall of the control cylinder 4 in such a way that the control borehole 8 overlaps at least partially with the circumferential groove 12a that is connected to the flow channel 11. In this way, in the normal position, the dosing chamber 6 is connected to an actuating chamber 13, in which the control borehole 8 opens out. The circumferential groove 12a in this case is spaced from the end adjacent to the dosing chamber 6 at such a distance that, in the normal position, the control element 5 is guided along the entire circumference by the control cylinder 4. In order to position the control element 5 in the normal position exactly with respect to the control borehole 8, the axial stroke of the control element 5 is restricted in the direction of the control chamber 3 by a stop, e.g., a retaining ring 14 inserted in the control cylinder.

In the discharge position of the control element 5 shown in FIG. 2, the control borehole 8 at least partially overlaps the circumferential groove 12b adjacent to the actuating channel 10. In this way, in the discharge position, the actuating channel 10 connects the control chamber 3 to the actuating chamber 13, into which the control borehole 8 opens up.

By means of lubricant which is located in the circumferential grooves 12 when the single line distributor 1 is operating, the guiding surfaces between the control element 5 and the control cylinder 4 are lubricated during the movement of the control element 5 between the normal position and the discharge position. As a result of the configuration as circumferential grooves, lubricant is distributed along the entire circumference of the control element 5, as a result of which damage to the guiding surfaces is especially reliably prevented. Furthermore, the control element 5 can be moved smoothly in the control cylinder as a result of the lubrication.

The control element 5 is pushed into its normal position by the bias element 7, developed in FIG. 1 as a compression spring by way of example. The compression spring 7 is arranged within the dosing chamber 6 between the control element 5 and a projection 7′, developed as a spring seat arranged in the control cylinder 4.

The control element 5 is pressed by the lubricant from its normal position shown in FIG. 1 to the discharge position shown in FIG. 2, whereby the lubricant flows into the control chamber 3 under pressure and presses axially against the control element 5. This compresses the bias element 7. The compressed bias element 7 simultaneously forms a stroke limitation for the control element 5 in the direction of the dosing chamber 6. Alternatively, the stroke can also be limited by a stop formed in the control cylinder 4. When the pressure of the lubricant flowing into the control chamber 3 drops, the bias element 7 presses the control element 5 from the discharge position back into the normal position. The bias element 7 and the diametric surface of the control element 5 determine the pressure generated by the control element 5 in the direction of the control chamber 3. In the single line distributor 1 according to the invention, this pressure is designed is such a way that the control element 5 can be pressed into the normal position with a residual pressure of the lubricant in the control chamber 3 of up to roughly 50 bar. This is especially advantageous, because lubricants, such as grease, for example, maintain a relatively high residual pressure at low temperatures and in the case of long lubricant lines.

In order to change the play between the control element 5 and the control cylinder 4 as a function of temperature, the control element 5 and the control cylinder 4 are manufactured of materials having different linear expansion coefficients. In this way, at low temperatures, when the lubricant has an especially high viscosity, more play is set and, at high temperatures, when the lubricant has an especially low viscosity, a small amount of play is set.

The dosing device 24 of the single line distributor 1 according to the invention comprises the actuating chamber 13, a dosing chamber 6 and a dosing piston 16 and surrounds the control device 9.

When the lubricant, which is under the actuating pressure, moves the control element 5 into its discharge position, as shown in FIG. 2, the lubricant flows through the actuating channel 10 and the control borehole 8 into the actuating chamber 13.

The actuating chamber 13, which is adjacent to the control element 5 as a result of the control borehole 8, is formed around the control cylinder 4. On the exterior, the actuating chamber 13 is bordered by a dosing cylinder 15, which is arranged concentrically around the control cylinder 4. The axial end of the dosing cylinder 15 that is adjacent to the actuating chamber 13 is sealed. Furthermore, the actuating chamber 13 is separated from the dosing chamber 6 by the dosing piston 16. The dosing piston 16, formed in the shape of a ring, is arranged within the dosing cylinder 15, and in such a way that it moves axially around the control cylinder 4.

The control cylinder 4 is formed as a guide rod for the dosing piston 16, on which the dosing piston 16 is arranged in such a way that it can be moved axially. The guiding surface of the dosing piston 16 that surrounds the control cylinder 4 is formed with a length along the axis that keeps the dosing piston from tilting. The inner surface of the dosing cylinder 15, into which the dosing piston slides back and forth, is developed as an additional guide for the dosing piston 16. The dosing cylinder 15 is developed as a thin-walled tube.

In order to seal the actuating chamber 13 with respect to the dosing chamber 6, one or more sealing elements 17 are arranged at the dosing piston 16. The sealing elements 17 seal the dosing piston 16 with respect to the dosing cylinder 15 and control cylinder 4. Alternatively, a single sealing element can also be mounted on the dosing piston, whereby this element then seals the dosing cylinder 15 with respect to the control cylinder 4.

If the pressurised lubricant that moves the control element 5 into its discharge position flows through the actuating channel 10 into the actuating chamber 13, the lubricant presses axially against the dosing piston 16 and moves it from its idle position shown in FIG. 1 into its actuation position shown in FIG. 2. The volume of the actuating chamber 13 is at a minimum when the dosing piston 16 is in the idle position and at a maximum when it is in the actuation position. The volume of the dosing chamber 6, on the other hand, is at a maximum in the idle position of the dosing piston 16 shown in FIG. 1 and at a minimum in the actuation position shown in FIG. 2. The dosing piston 16 is pressed in the direction of its idle position by an additional spring element 18 arranged in the dosing chamber 6.

The dosing piston 16 separates the actuating chamber 13 from the dosing chamber 6, which is divided into two sub-chambers 19, 20. The first, inner sub-chamber 19 of the dosing chamber 6 is formed within the control cylinder 4, adjacent to the control element 5, and connected to a discharge opening 21 of the single line distributor 1. In the case of the embodiment shown in FIG. 1 by way of example, the discharge opening 21 is arranged so that it is opposite the control element 5, on the axial end of the control cylinder 4. The inner sub-chamber 19 is connected to the outer sub-chamber 20 of the dosing chamber 6 by a passage 22 in the control cylinder 4, whereby this outer sub-chamber 20 is arranged around the control cylinder 4.

In the embodiment shown in FIG. 1 to 3, the passage 22 is formed as a radial borehole, which is easy to manufacture, in the control cylinder 4. In the axial direction of the control cylinder 4, the passage 22 is arranged in such a way that it is not blocked by the dosing piston 16 at any time. The sub-chambers 19, 20 of the dosing chamber 6 are consequently always connected to each other.

The outer sub-chamber 20 of the dosing chamber 6 is formed between the dosing cylinder 15 and control cylinder 4, and is bordered axially on one side by the dosing piston 16. On the other side, it is sealed by a cap screw 23 formed as a plug. The cap screw 23 is developed in a rotationally-symmetrical manner and has a channel through which the control cylinder 4 penetrates. The cap screw 23 has an external screw thread 23′, with which it engages in the dosing cylinder 15, which has an internal screw thread. The dosing amount of the single line distributor 1 according to the invention changes, depending on the depth to which the cap screw 23, which forms a dosing piston stop 23″, is screwed in. As a result of the self-obstruction of the thread, the cap screw 23 is held in that position at which it is set. The dosing piston stop 23″, which is connected to the dosing cylinder 15, consequently forms an adjustment device for the single line distributor 1 according to the invention, whereby this adjustment device can be used to adjust the dosing piston stroke. The cap screw 23 can have a scale 23′″ (FIG. 3) on which the selected dosing amount can be read off.

The control cylinder 4 is developed as a thin-walled tube, in which the one axial end forms the inlet opening 2 and the other, opposing axial end forms the discharge opening 21. The control cylinder 4 is consequently structurally especially simply developed and can be manufactured economically.

When the dosing piston 16 moves from the idle position shown in FIG. 1 into the actuation position shown in FIG. 2 as a result of the pressurized lubricant that flows into the actuating chamber 13, the volume of the outer sub-chamber 20 is reduced. In this way, lubricant located in the outer sub-chamber 20 is pressed through the passage 22 and the inner sub-chamber 19, likewise filled with lubricant, and out of the discharge opening 21. The lubricant is directed from the discharge opening 21 in the direction of a lubricating point, not shown in FIG. 1.

With the movement of the dosing piston 16 from the idle position into the actuation position, the spring element 18, located in the dosing chamber 6 between the dosing piston 16 and plug 23, is compressed. In the case of the embodiment of the single line distributor 1 according to the invention shown in FIG. 1 by way of example, the additional spring element 18 is arranged as a compression spring.

The dosing piston 16 of the single line distributor 1 according to the invention remains in its actuation position shown in FIG. 2 until the pressure of the lubricant located in the actuating chamber 13 drops. This is normally achieved by switching off a lubricant pump, not shown in FIG. 2, with the subsequent pressure relief. When there is a drop in the pressure of the lubricant located in the control chamber 3 and the actuating chamber 13, the bias element 7 first presses the control element 5 from its discharge position into its normal position, as shown in FIG. 1. In the normal position, the flow or bypass channel 11 of the control element 5 connects the actuating chamber to the inner sub-chamber 19 of the dosing chamber 6. The second bias element 18 presses axially against the dosing piston 16 and moves it axially from its actuation position into its idle position. At the same time, the dosing piston 16 presses the lubricant located in the actuating chamber 13 through the flow channel 11 into the dosing chamber 6. The lubricant now located in the dosing chamber 6 is discharged at the lubricating point the next time the single line distributor 1 is actuated, as described above.

The control device 9 is surrounded by the dosing device 24 in the single line distributor 1 according to the invention. In this way, it is possible to implement an especially compact construction of the single line distributor 1 according to the invention. The axial cross-section area of the control element 5 here is smaller than that of the dosing piston 16. Because of the small cross-sectional area, the control element 5 can even be pressed into its normal position against the relatively high residual pressures of the lubricant. On the other hand, the dosed amount of lubricant that is discharged at the lubricating point per actuation is relatively large, because of the large cross-sectional area of the dosing piston.

FIG. 3 shows a schematic representation of an arrangement 25 according to the invention with a number of single line distributors 1 and a lubricant distributor channel 26. The lubricant distributor channel 26 can be connected to a lubricant source, not shown in FIG. 3, with a supply opening 27. A number of single line distributors 1 are connected to the lubricant distributor channel 26. Here the single line distributors 1 are arranged next to one another along the length of the lubricant distributor channel 26, in such a way that they protrude outwards from the lubricant distributor channel. Every second single line distributor 1 here is arranged in the same protrusion direction A, A′. The two rows of single line distributors 1 formed in this way, with the protrusion directions A and A′, are shown in FIG. 3 by way of example. In order to ensure good access to the individual single line distributors 1, the two protrusion directions A, A′ are arranged so as to form a V-shape. In the arrangement 25 shown in FIG. 3 by way of example, the angle α between the two protrusion directions A, A′ is roughly 20°. Alternatively, the single line distributors 1 can also protrude from the lubricant distributor channel 26 in the same protrusion direction A, A′.

FIG. 4 shows a schematic representation, in section, of a further embodiment of a single line distributor 1 according to the invention. In the following, the differences to the embodiments described above are described. The same reference numbers are used for parts that are the same.

In the case of the embodiment shown in FIG. 4, the control element 5, shown in its normal position, is developed without the actuating channel 10. In the normal position, the actuating chamber 13 is connected to the dosing chamber 6 by the flow channel 11, formed in the control element 5. The control borehole 8 releases the end of the flow channel 11. In the discharge position, not shown here, the control element 5 is pressed against a control element stop 31 formed in the control cylinder 4. In this case, the control element 5 releases the connection from the control chamber 3 to the control borehole 8, as a result of which the control chamber 3 is connected to the actuating chamber 13.

In the embodiment shown in FIG. 4, the discharge opening 21 is formed in the cap screw 23a, at which a lubricant line (not shown) leading to the lubricating point can be attached. The discharge opening 21 here is given a preferably standardised internal screw thread, into which the lubricant line, formed with a corresponding external screw thread, can be screwed. Alternatively, a plug-connection can also be developed in the discharge opening 21, whereby the lubricant line can be inserted into this plug-connection in such a way that fluids do not leak. The cap screw 23a is given an external screw thread 23′ and screwed into the dosing cylinder 15. Unlike in the case of the embodiment shown in FIGS. 1 and 2, the cap screw 23a is screwed into the dosing cylinder 15 as far as an indentation 32. In the case of the embodiment shown in FIG. 4, the cap screw 23a can be replaced with another cap screw with a dosing piston stop 23a″ with a different length. The dosing amount of the single line distributor 1 according to the invention, as shown in FIG. 4, can be varied in this way. Alternatively, the dosing piston stop 23a″ can also be arranged on the dosing piston 16.

FIG. 5 schematically shows a further embodiment of the single line distributor 1 according to the invention, in section. The same reference numbers are used for parts that are the same.

In the case of the embodiment shown in FIG. 5, unlike that shown in FIG. 4, the dosing piston stop 23b″ is developed with an adjustment screw 23b and they are connected to one another via a screw thread. Furthermore, the adjustment screw 23b is inserted into the dosing piston 15 in an insertion direction E. The adjustment screw 23b is arranged in the dosing piston 15 in such a way that it fits perfectly and can be rotated in it about the longitudinal axis of the single line distributor. The adjustment screw 23b is held axially by a positioning sleeve 28 to prevent it from sliding out of the dosing piston 15. The positioning sleeve 28 is connected to the dosing piston 15 by some means of attachment, such as a screw 29, for example. The dosing piston stop 23b″ can be adjusted by means of a screw-thread drive. The screw-thread drive is formed by the dosing piston stop 23b″, which has a female thread and which is connected to the adjustment screw 23b, which is equipped with an external screw thread.

When the adjustment screw 23b of the embodiment shown in FIG. 5 is turned, the dosing piston stop 23b″ moves back and forth in the direction of the stroke of the dosing piston 16, depending on the direction in which it is turned. Due to this screw-thread drive arrangement of the adjustment screw 23b with the dosing piston stop 23b″, the stroke of the dosing piston 16 can be changed, and, as a result, the dosing amount of the single line distributor 1 according to the invention can be adjusted, without the outside length of the single line distributor 1 changing.

Further modifications of the embodiments described are conceivable. For example, the control element can be formed completely without channels and, instead, completely sweep across the control opening during the movement from the normal position into the discharge position, so that it is arranged on one side of the control opening in the discharge position and on the other side of the control opening in the normal position.

1. Single line distributor (1) for dosed discharge of lubricant at a lubricating point, with a control device (9) comprising a control element (5) which can be moved from a normal position into a discharge position and is pressed by a bias element (7) into said normal position, and a control chamber (3) which is connected to an inlet opening (2) and which is separated from a dosing chamber (6) by means of the control element (5), and with a dosing device (24) comprising a dosing piston (16), the dosing chamber (6) which is connected to a discharge opening (21), and an actuating chamber (13) which is separated from the dosing chamber (6) by the dosing piston (16) and which is adjacent to the control element (5), whereby the actuating chamber (13) is connected to the control chamber (3) in the discharge position and is connected to the dosing chamber (6) in the normal position, characterised in that the control device (9) is surrounded by the dosing device (24).

2. Single line distributor (1) according to claim 1, characterised in that the control element (5) is arranged movably in a control cylinder (4) and the dosing piston (16) is arranged movably around the control cylinder (4).

3. Single line distributor (1) according to claim 1 or 2, characterised in that the dosing piston (16) is arranged movably in a dosing cylinder (15).

4. Single line distributor (1) according to one of the abovementioned claims, characterised in that the dosing piston (16) is formed as a ring piston.

5. Single line distributor (1) according to one of the abovementioned claims, characterised in that the dosing chamber (6) is divided into two sub-chambers (19, 20), wherein the inner sub-chamber (19), which is adjacent to the control element (5), is formed in the control cylinder (4) and the outer sub-chamber (20), which is adjacent to the dosing piston (16), is formed in the dosing cylinder (15).

6. Single line distributor (1) according to claim 5, characterised in that the two sub-chambers (19, 20) of the dosing chamber (6) are connected to each other by means of a passage (22) in the control cylinder (4).

7. Single line distributor (1) according to claim 5 or 6, characterised in that the volume of the inner sub-chamber (19), which is adjacent to the control element (5), is smaller than the volume of the outer sub-chamber (20), which is adjacent to the dosing piston (16).

8. Single line distributor (1) according to one of the abovementioned claims, characterised in that at least one sealing element (17) is arranged on the dosing piston (16), by means of which the dosing piston (16) is arranged between the dosing cylinder (15) and the control cylinder (4) in such a way that it is sealed.

9. Single line distributor (1) according to one of the abovementioned claims, characterised in that the dosing piston (16) is pressed in the direction of the actuating chamber (13) by an additional bias element (18).

10. Single line distributor (1) according to claim 9, characterised in that the additional bias element (18) is arranged within the dosing chamber (6).

11. Single line distributor (1) according to one of the abovementioned claims, characterised in that a control opening (8) is formed in the control cylinder (4), wherein the actuating chamber (13) is connected to the dosing chamber (6) in the normal position and to the control chamber (3) in the discharge position by means of this control opening.

12. Single line distributor (1) according to one of the abovementioned claims, characterised in that one of the axial ends of the control cylinder (4) is formed as the inlet opening (2).

13. Single line distributor (1) according to one of the abovementioned claims, characterised in that one of the axial ends of the control cylinder (4) is formed as the outlet opening (21).

14. Single line distributor (1) according to one of the abovementioned claims, characterised in that an actuating channel (10) is formed in the control element (5), by means of which the actuating chamber (13) is connected to the control chamber (3) in the discharge position and is separated from the control chamber (3) in the normal position.

15. Single line distributor (1) according to claim 14, characterised in that an orifice of the actuating channel (10) is formed on the circumference, across the stroke axis of the control element (5), with the orifice being at least partially overlapped by the control opening (8) in the discharge position and closed by the control cylinder (4) in the normal position.

16. Single line distributor (1) according to one of the abovementioned claims, characterised in that a flow channel (11) is formed in the control element (5), by means of which the actuating chamber (13) is connected to the dosing chamber (6) in the normal position and separated from the dosing chamber (6) in the discharge position.

17. Single line distributor (1) according to claim 16, characterised in that an orifice of the flow channel (11) is formed on the circumference, across the stroke axis of the control element (5), in such a way that it at least partially overlaps the control opening (8) in the normal position and is closed by the control cylinder (4) in the discharge position.

18. Single line distributor (1) according to claim 15 or 17, characterised in that the control element (5) has at least one circumferential groove (12) radial to the stroke axis, in which an orifice of the actuating channel (10) or an orifice of the flow channel (11) is arranged.

19. Single line distributor (1) according to one of the abovementioned claims, characterised in that the control element (5) and the control cylinder (4) are produced from materials having different linear expansion coefficients and in that the play between the control element (5) and the control cylinder (4) is greater at a first operating temperature than at a second operating temperature, which is higher than the first.

20. Single line distributor (1) according to one of the abovementioned claims, characterised in that the single line distributor (1) comprises an adjustment device by means of which the axial stroke of the dosing piston (16) can be adjusted.

21. Single line distributor (1) according to claim 20, characterised in that the adjustment device comprises a dosing piston stop (23″) that can be set at various positions in the stroke direction of the dosing piston (16), whereby this dosing piston stop is arranged at the dosing cylinder (15) or dosing piston (16).

22. Single line distributor (1) according to claim 20, characterised in that the adjustment device comprises a dosing piston stop (23a″) arranged at a fixed position in the stroke direction of the dosing piston (16), wherein this dosing piston stop is connected to the dosing cylinder (15) or dosing piston (16) in such a way that it is interchangeable.

23. Single line distributor (1) according to claim 20, characterised in that the adjustment device comprises a dosing piston stop (23b″) that can be moved in the stroke direction of the dosing piston (16), wherein this dosing piston stop is connected to an adjustment screw (23b) that is arranged on the dosing cylinder (15) in such a way that it can move.

24. Arrangement (25) for the dosed discharge of a lubricant at a number of lubricating points with a number of single line distributors (1), and with a lubricant distributor channel (26) that is developed in such a way that it can be connected to a lubricant source, wherein the single line distributors (1) are connected to the lubricant distributor channel (26) and are arranged in such a way that they protrude from the lubricant distributor channel (26), characterised in that the single line distributors (1) are developed according to one of the abovementioned claims.

25. Arrangement (25) according to claim 24, characterised in that the single line distributors (1) are arranged next to one another on the lubricant distributor channel (26) and alternatingly protrude in the same protrusion directions (A, A′) from the lubricant distributor channel (26), wherein the two protrusion directions (A, A′) are arranged in such a way that they form a V-shape.

26. Arrangement (25) according to claim 24, characterised in that the single line distributors (1) are arranged next to one another on the lubricant distributor channel (26) and protrude from the lubricant distributor channel (26) in the same protrusion direction (A, A′).
